(19) United States
(12) Patent Application Publication
(10) Pub. No.: US 2005/0276894 A1
(43) Pub. Date: Dec. 15, 2005

(54) Method for formulating pasta

(76) Inventor: George R. Royer, Toledo, OH (US)

Correspondence Address: George R. Royer;Attorney at Law, Suite 416, 316 N. Michigan Street, Toledo, OH, 43624, US

(21) Appl. No.: 10/346,639

(22) Filed: Jan. 21, 2003

(51) Int. Cl. A01J 1/00

(52) U.S. Cl. 426/512

(57) ABSTRACT

The subject invention is a method for formulating pasta into larger segments for consumption purposes generally including the steps for having uncooked pasta heated and/or cooked in a conventional manner and taking the cooked portion of pasta and molding such portions of cooked pasta together by heat, pressure, or a combination of both heat and pressure or by other methods, so as to produce a unitary portion of pasta of a larger size than the individual pasta portions that are molded together.

### DISCUSSION OF PRIOR ART AND BACKGROUND OF THE INVENTION

Pasta is usually formulated initially into thin strands or layers for subsequent heating or cooking for eventual consumption. Part of the rationale for producing pasta into thin layers or strand portions is that it is readily cooked to achieve uniform cooking throughout the pasta member. Specifically, relatively thick pasta portions cannot be cooked to the same degree throughout as this would lead to an undesirable result for the consumption of the pasta.

Alternatively stated, one of the problems with existing methods of preparing and cooking pasta under existing conditions is that it must generally be cooked in relatively thin strands or layers, in order to achieve any consistency in the cooking process. If a pasta strand or layer is too thick, the inner portion will not be cooked properly for satisfactory consumption purposes. In this respect, the individual cooked pasta product is usually a thin layer or strand which is consumed in forms like lasagna or spaghetti or another form. For the hearty eaters the preference is usually to have to a larger pasta portion to masticate, particularly one which can be cooked and stored or packaged and later reheated for consumption. There is thus a need for a process to accomplish this result.

### OBJECTS OF THE INVENTION

It is an object of this invention to provide an improved method of preparing pasta;

It is also an object of this invention to provide an improved larger pasta product for consumption purposes;

Another object of this invention is to provide an improved method of preparing food, particularly pasta;

Yet another object of this invention is to provide an improved method of uniformly preparing food;

It is also an object of the subject invention to provide a more hearty portion of pasta for consumption purposes;

Other and further objects of this invention will become apparent from reading of the claims taken in conjunction with the claims.

### DESCRIPTION OF GENERAL EMBODIMENT AND SUMMARY OF THE INVENTION

The subject invention is an improved method for formulating pasta into larger segments for consumption purposes generally including the steps for having uncooked pasta heated in a liquid and cooked in a conventional manner and taking the cooked portion of pasta and melding such portions of cooked pasta together, for molding said portions of cooked pasta together into a unitary portion by heat, pressure, or a combination of both by other methods.

The general method of preparing pasta into larger portions for consumption purposes and generally comprises the following steps:
1) Cooking individual layers or strands of pasta in a liquid or other medium by heating said pasta strands or layers for a period of time;
2) Taking the cooked strands or layers of the pasta and placing them together into a mass;
3) Taking the mass of cooked pasta strands of layers and molding them together in a congealed manner by heat, pressure or a combination of heat and pressure or other means.

### DESCRIPTION OF PREFERRED EMBODIMENT

The following description of the subject invention covers one preferred or the subject member and description of a singular embodiment shall not be considered as limiting the scope of the subject invention to as set forth to the claims herein.

The subject invention involves is an improved method for formulating pasta into larger segments for consumption purposes generally including the steps for having uncooked pasta heated in a liquid or otherwise cooked, and then taking the individual cooked portions of pasta and molding such portions of cooked pasta together, for molding said portions of cooked pasta together into a unitary portion, by using heat, pressure or a combination of heat and pressure, or other methods, in order to yield a larger portion of pasta.

The general method of preparing pasta into portions for consumption purposes as contemplated herein generally comprises the following general steps:
1) Cooking or heating individual portions of uncooked pasta by such pasta strands or layers for a period of time;
2) taking a quantity of such cooked portions of the pasta and placing them together together in a mass;
3) molding the mass of cooked pasta portions and molding them together in a congealed manner by using heat or pressure of a combination of heat and pressure or using other means;

In alternate forms of the subject invention, the cooked strands or layers of pasta may be immersed or exposed to substances to help the congealing and molding process. For this purpose certain vegetable oils may be used or egg whites, corn starch, or other similar substances to help ready the cooked or heated pasta portions for molding with the other cooked portions of pasta.

Alternately stated the subject invention involves a process for preparing pasta into a larger portion for consumption and is comprised of the following general steps:
1) heating or cooking individual uncooked pasta strands or layers;
2) taking a plurality of the resultant heated pasta strands or layers and placing them together in a mass;
3) applying pressure, heat, or a combination of both or using some other means to congeal and mold the mass of heated pasta strands or layers to formulate a portion of pasta comprising the plurality of cooked or heated pasta strands or layers.

In yet another embodiment, tomato paste, other condiments or food substances can be added to the cooked strands or layers of pasta to blend in with the congealed strands of pasta. The resultant congealed product can be consumed right after molding or stored for later reheating and consumption.

Once the molded portions of pasta are so formed, they may still be warm immediately after the molding process and be edible in the warm state. Otherwise, the resultant molded products can be frozen, dehydrated, or otherwise stored in some form for future use by heating such product which has been pre-cooked in a microwave or by other means. Since the molded products are pre-cooked it is not difficult to heat a thicker pasta product for consumption.

In this procedure, it is preferable to clump the heated or cooked pasta strands into a mass so that the pressure exerted on the resultant clumps will solidify the mass or clump of strands into a unitary piece or portion of pasta, preferable as a cake-like member in which the resultant congealed portions will be of a thicker dimension. The process of heating the mass of separate strands of pasta with water, oil, or other liquids will render the individual strands more pliable, and moist so that the individual strands are more susceptible to be congealed and molded together. However, if the individual strands are over heated or over cooked, the resultant strands will become too mushy or soft to hold up sufficiently under pressure and the molding process will be hampered accordingly. If on the other hand, the strands of pasta are not sufficiently cooked to make them somewhat pliable the molding process will become more difficult accordingly.

In this molding process use of a mold can be used to achieve and result as described above. For this purpose the mold can be comprised of an open or closed container like member into which the cooked or heated pasta portions are placed to be molded under the pressure or heat, or other means as described above. Such a mold can be equipped with a pressure plunger that will squeeze the mass of cooked pasta strands into a more dense state. The mold can have heat means to direct heat to the sides or the bottom of the mold container. Additionally, the pressure plunger may have heating means therein to apply heat along with pressure in the molding process or it may be cooked and packaged for latter consumption. Once the mass of cooked or heated pasta strands are so molded the resultant molded product can be cooled and packaged and store for later reheating.

1. A method of preparing pasta comprising
1) heating individual uncooked pasta strands or layers;
2) taking a plurality of the heated pasta strands and placing them together in a mass;
3) applying pressure to congeal and mold said mass of heated pasta strands to formulate a portion of pasta comprising the congealed pasta strands or layers:

2. A method of preparing past comprising
1) heating individual uncooked pasta strands or layers;
2) taking plurality of the heated pasta strands and placing them toegether in a mass;
3) applying pressure to congeal and mold said mass of heated pasta strands to formulate a portion of pasta comprising the congealed pasta strands or layers.

3. A Method of Preparing pasta comprising:
1. heating individual uncooked pasta portions;
2. taking a plurality of said heated pasta portions placing them together in a mass;
3. Applying pressure and hear of both to congeal and mold said mass of heated pasta portions to formulate a resultant portion of pasta comprising the congealed portions of cooked pasta portions
